(19) United States
(12) Patent Application Publication
(10) Pub. No.: US 2023/0130133 A1
(43) Pub. Date: Apr. 27, 2023

(54) IMAGE FORMING APPARATUS CALCULATING FEE, METHOD FOR CONTROLLING IMAGE FORMING APPARATUS, AND STORAGE MEDIUM

(71) Applicant: CANON KABUSHIKI KAISHA, Tokyo (JP)

(72) Inventor: Tateki Narita, Tokyo (JP)

(21) Appl. No.: 18/048,790

(22) Filed: Oct. 21, 2022

(30) Foreign Application Priority Data
Oct. 27, 2021 (JP) 2021-175287

(51) Int. Cl. G06Q 30/02; G07F 17/26

(52) U.S. Cl. CPC G06Q 30/0283; G07F 17/26

(57) ABSTRACT

In a direct print function, a file analysis is performed internally by an image processing apparatus, and a user looks at an output result (such as a printed matter) and checks whether the output result matches a selected image file. Therefore, when fee settlement is performed before the image processing apparatus prints the output data, regardless of the contents of the selected file, the fee is calculated by applying settings at the time of an operation request (e.g., the output method is full color) to all pages of all files, which may result in too expensive charges. Accordingly, fee calculation is performed after determining whether color or monochrome printing is performed on a per-page basis.

### BACKGROUND

### Field of the Disclosure

The present disclosure relates to an image forming apparatus calculating a fee upon printing, a method for controlling the image forming apparatus, and a storage medium.

### Description of the Related Art

An electrophotographic image processing apparatus equipped with a scanner and a printer can send an image read by the scanner to an external apparatus, or print page description language (PDL) data or an image file that has been received.

Hitherto, there has been an environment where such an image processing apparatus is installed in each office of a company or a business operator and is used by employees, and the fees for using functions and the maintenance costs are collectively borne by the company or the business operator. In the future, however, there is a need for an environment (e.g., public spaces, retail stores, and shared office spaces) in which the image processing apparatus is used by various users with different payments, and the fees are settled on a per-user basis, even within the company.

In such an environment, after the image processing apparatus accepts an operation request, before transmitting or printing output data, control is required to execute transmission or printing after settling the fee for a user. Fee settlement is executed by, for example, connecting to an external settlement system.

In contrast, the image processing apparatus can receive and print an image file as described above, and these functions are referred to as direct printing. An image file is received via a network; or an external storage medium such as a Universal Serial Bus (USB) memory stick is connected, a desired file is selected from among image files saved in the medium, and the desired file is received. In the case of receiving an image file directly as described above, the image processing apparatus analyzes the file to determine whether the file includes color data or monochrome data, and to determine whether the file can be output by using the capability of the image forming apparatus.

Determination of the usage fee of the image processing apparatus requires information on whether such an output method is full color or monochrome, and information on whether the image file can be output by the image processing apparatus, and, in order to accept the determined usage fee, it is also necessary for the user to be able to check the contents of the information.

Japanese Patent Laid-Open No. 2007-237608 presents, for index printing in direct printing, a technique for printing the total number of pages in addition to the file name of a Tag Image File Format (TIFF) file.

However, such a file analysis has been conventionally performed internally by the image processing apparatus, and the user looks at the output result (such as a printed matter) and checks whether the output result matches the selected image file. Therefore, when fee settlement is performed before the image processing apparatus prints the output data, regardless of the contents of the selected file, the fee is calculated by applying settings at the time of the operation request (e.g., the output method is full color) to all pages of all files, which may result in redundant charges (too expensive charges).

In contrast, in a method of calculating the fee after completely generating the output data of the selected file, it takes time from the operation request to the fee settlement, resulting in decreased convenience, and, if the storage capacity of the image processing apparatus is small, not all the output data can be saved.

### SUMMARY

Means is desired by which the user can accurately check the fee beforehand without reducing the convenience of fee settlement or increasing the cost due to the addition of a storage capacity.

Embodiments of the present disclosure provide an image forming apparatus including: an obtaining unit configured to obtain a plurality of files from an external apparatus; a control unit configured to, for one or some of the plurality of files obtained by the obtaining unit, while applying control to display information on the one or some files on a display unit, apply control not to display information on one or more remaining files on the display unit; a fee calculation unit configured to calculate a fee for the one or some files in preference to the one or more remaining files; and an acceptance unit configured to accept a selection of one or more files to be printed from among the one or some files whose information is displayed by the control unit. The fee calculation unit includes: a determination unit configured to determine whether each page of each file of the plurality of files obtained by the obtaining unit is a color page or a monochrome page; and a unit configured to calculate a fee for printing each file based on a result of determination of each page performed by the determination unit.

Further features of the present disclosure will become apparent from the following description of exemplary embodiments with reference to the attached drawings.

### BRIEF DESCRIPTION OF THE DRAWINGS

FIG. 1 illustrates the hardware configuration of an image processing apparatus.

FIG. 2 illustrates an output after settlement in a direct print function.

FIG. 3 illustrates an example of a print fee table.

FIG. 4 illustrates an output result and a fee in the direct print function.

FIG. 5 illustrates detailed display of the number of pages after a file analysis in an embodiment.

FIG. 6 illustrates a flowchart in the embodiment.

### DESCRIPTION OF THE EMBODIMENTS

Hereinafter, the best mode of implementing embodiments of the present disclosure will be described using the drawings. Note that a program of a control unit (115) according to a flowchart of an image processing apparatus is stored in a read-only memory (ROM) (102) of the control unit (115), read to a random-access memory (RAM) (104), and executed by a central processing unit (CPU) (103).

In the following embodiment, an image processing apparatus (100) prints an image file obtained from an external storage medium; however, this is not the only possible method of obtaining an image file, and an image file may be obtained from an external apparatus connected to a network.

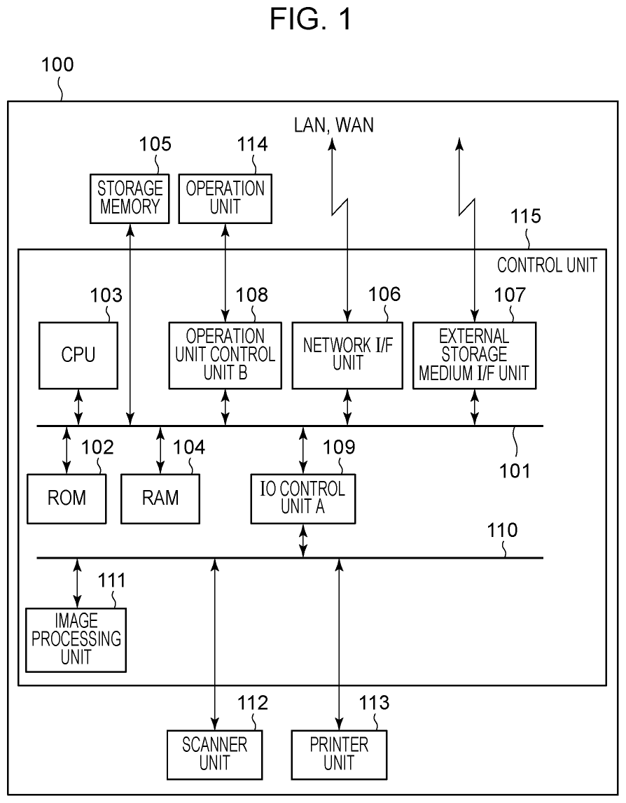

FIG. 1 is a block diagram illustrating the hardware configuration of an image processing apparatus and an information processing apparatus according to the embodiment of the present disclosure. Unless otherwise noted, as long as the functions of the present disclosure are executed, the present disclosure is applicable to a single device or a system composed of multiple devices.

Each component of the control unit (115) of the image processing apparatus (100) is connected to a system bus (101) and an image bus (110). The ROM (102) is a ROM in which the boot program of the system is stored. System software for realizing each unit of the present disclosure is stored in the ROM (102) or a storage memory (105) and is executed by the CPU (103). The RAM (104) is a system work memory area for the CPU (103) to execute software, and is also an image memory for temporary storage when processing image data. The storage memory (105) is used as an internal storage.

Data read from a scanner unit (112), image data, system software, and the like are stored in the storage memory (105). The storage memory (105) is composed of a hard disk drive (HDD) or a solid state drive (SSD). A network interface (I/F) unit (106) is an I/F unit for establishing a connection via a local area network (LAN) or a wide area network (WAN), and receives/outputs information from/to each connected device. An external storage medium I/F unit (107) is an I/F unit for connecting to an external storage medium such as a USB memory stick, and receives/outputs information from/to the connected external storage medium. These devices are arranged on the system bus (101). An input/output (I/O) control unit A (109) is a bus bridge that connects the system bus (101) and the image bus (110), which transfers image data at high speed, and converts the system bus (101) data structure. The image bus (110) is composed of a general-purpose bus such as a Peripheral Component Interconnect (PCI) bus, Institute of Electrical and Electronics Engineers (IEEE) 1394, or Peripheral Component Interconnect Express (PCIEx). The following devices are arranged on the image bus (110). The scanner unit (112) and a printer unit (113), which are image input/output devices, are connected to an image processing unit (111), and synchronous/asynchronous system conversion of image data is performed. The image processing unit (111) is composed of a plurality of application-specific integrated circuits (ASICs) that perform image processing such as resolution conversion, compression and decompression, and binary-to-multivalue conversion on input and output image data. An operation unit control unit B (108) for image data is an interface unit with an operation unit (114) (UI=User Interface), and outputs image data to be displayed on the operation unit (114) to the operation unit (114). In addition, the operation unit control unit B (108) serves to convey information input by the user of the present system from the operation unit (114) to the CPU (103). The operation unit control unit B (108) is an I/F unit for software to control the operation unit (114) equipped with a display device, a keypad device, and a card reader device. In embodiments of the present disclosure, the operation unit (114) is composed of a liquid crystal display (LCD) touchscreen or the like, and interprets and displays a Video Graphics Array (VGA) signal output from the operation unit control unit B (108).

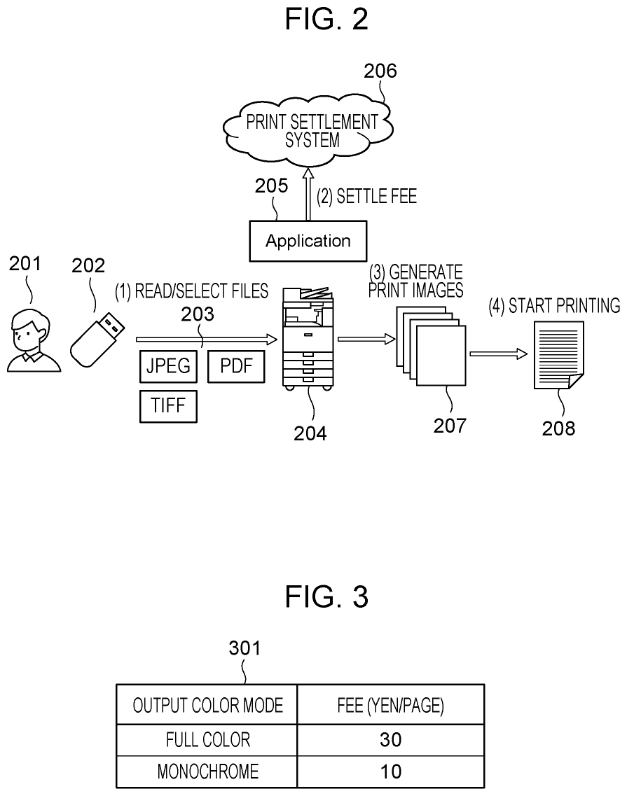

FIG. 2 illustrates an output after settlement in a direct print function.

Here, an image processing apparatus (204) is the image processing apparatus (100) illustrated in FIG. 1.

A user (201) connects a USB memory stick (202) to the external storage medium I/F unit (107) of the image processing apparatus (204). Here, various files (203) such as Joint Photographic Experts Group (JPEG), TIFF, and Portable Document Format (PDF) files are saved in the USB memory stick (202). The image processing apparatus (204) displays a list of the files (203) on the operation unit (114), and the user (201) selects one or more desired files from the list, and, using the operation unit (114), sets the output color mode and the like and makes a print operation request.

The ROM (102) of the image processing apparatus (204) is equipped with an application (205) for controlling settlement. The application (205) performs fee calculation according to the settings of the print operation request and the number of pages of the selected file(s), and makes a settlement request to a print settlement system (206) connected by the network I/F unit (106).

When the application (205) receives a notification of settlement completion from the print settlement system (206), the image processing apparatus (204) analyzes the selected file(s), generates a print image (207) of each page of each file, and prints it on a paper medium or the like (208).

FIG. 3 illustrates an example of a print fee table.

A print fee table (301) is referenced at the time of fee calculation. Here, if the output color mode is full color, the fee is 30 yen per page, and, if the output mode is monochrome, the fee is 10 yen per page.

The print fee table (301) is saved in the ROM (102) of the image processing apparatus (100) and referenced by the application (205), or may be held by the print settlement system (206) and reported to the application (205) in response to a settlement request.

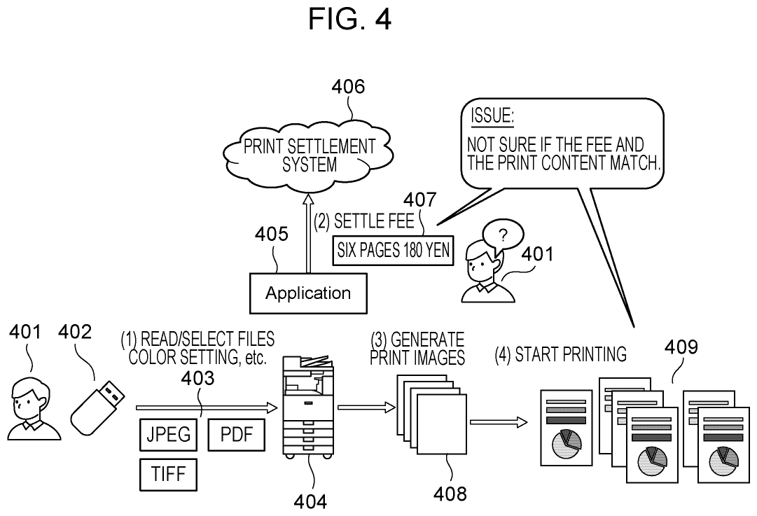

FIG. 4 illustrates an output result and a fee in the direct print function.

Reference numerals 401 to 404 are the same as reference numerals 201 to 204 illustrated in FIG. 2. Here, suppose that files selected by a user (401) are the following: file A (JPEG format, one color page), file B (TIFF format, one color page, two monochrome pages, and one not-outputtable page), and file C (PDF format, one color page and one monochrome page). Before a file analysis, simple information such as the number of pages of each file is recognizable, but detailed information (color/monochrome, determination on whether output is possible) is unknown.

Here, the user (401) makes a request for printing in full color of the output color mode.

The application (405) refers to the print fee table (301), calculates the fee for six full-color pages at 30 yen per page as a total of 180 yen, and displays the fee on the operation unit (114) (407).

When the user (401) notifies acceptance of the fee (407) using the operation unit (114), the application (405) makes a settlement request to the print settlement system (406).

When the application (405) receives a notification of settlement completion from the print settlement system (406), the image processing apparatus (404) analyzes the selected files, generates a print image of each page of each file (408), and prints it on a paper medium or the like (409).

Here, however, the user (401) checks a printed matter (409) output as a result of the file analysis and recognizes that the printed matter (409) as having three color pages and three monochrome pages. Accordingly, the user (401) recognizes that the contents of the printed matter (409) do not match the contents accepted on the fee display (407).

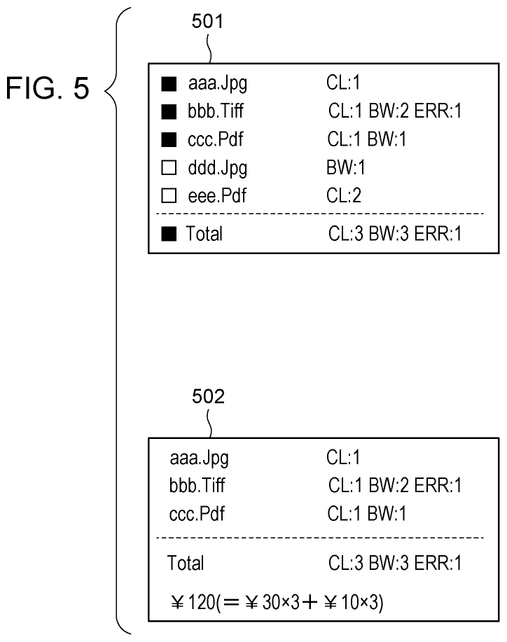

FIG. 5 illustrates detailed display of the number of pages after a file analysis in the present embodiment.

Display of a screen (501) and a screen (502) in the example illustrated in FIG. 4 will be described.

The screen (501) is a screen on which the image processing apparatus (404) displays a list of files in a USB memory stick (402) when the user (401) selects one or more files to be printed.

The screen (501) displays five files (aaa.Jpg, bbb.Tiff, ccc.Pdf, ddd.Jpg, and eee.Pdf), and the user (401) selects three files (aaa.Jpg, bbb.Tiff, and ccc.Pdf).

Here, the image processing apparatus (404) conducts a file analysis of the files to be displayed (no print image generation is performed), and displays the analysis result on the screen (501). Therefore, the screen (501) displays the number of pages of color pages, monochrome pages, and not-outputtable pages.

The screen (502) is a screen displayed by the image processing apparatus (404) and the application (405) when the user (401) accepts the fee, and is displayed instead of fee display (407).

The screen (502) displays the files selected on the screen (501) and the file analysis result thereof, and also displays a fee calculated according to the number of pages (color pages, monochrome pages, and not-outputtable pages) based on the file analysis result.

Accordingly, no redundant charges are included, and the user (401) can check that the contents accepted on the screen (502) and the contents of the printed matter (409) match.

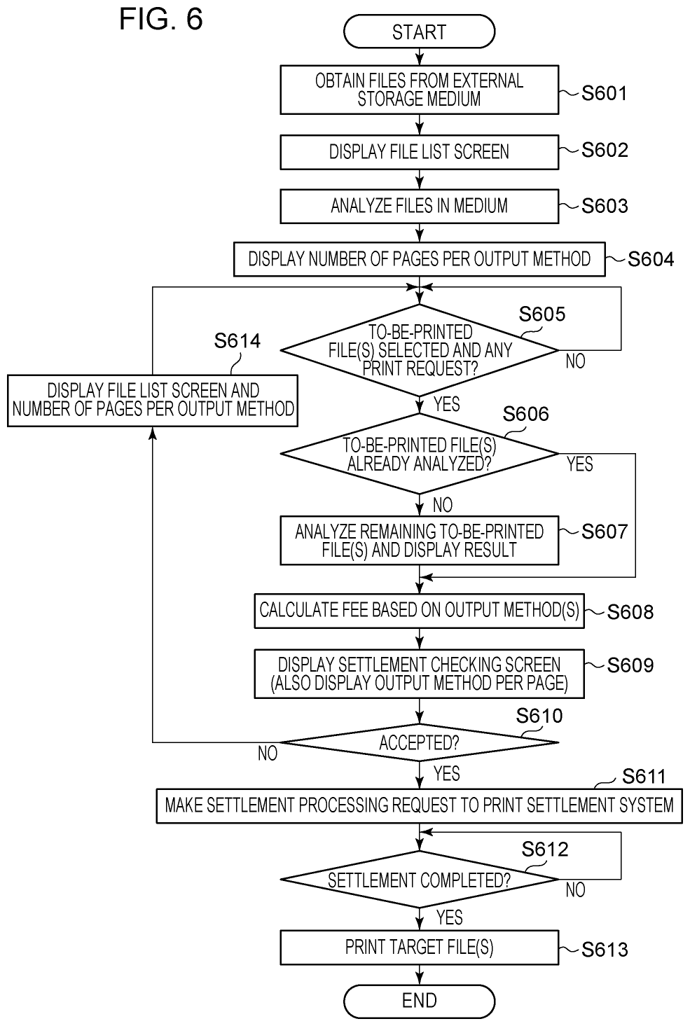

FIG. 6 illustrates a flowchart in the present embodiment.

The CPU (103) refers to and obtains file information in an external storage medium connected to the external storage medium I/F unit (107) (S601), and displays the file list screen (501) indicating a list of files on the operation unit (114) (S602).

The CPU (103) sequentially analyzes the content details of the files (S603), and sequentially adds and displays the number of pages per output method on the file list screen (S604).

In response to selection of one or more files to be printed and making of a print request on the file list screen (501)(S605), if not all the to-be-printed file(s) have been analyzed (S606), the CPU (103) analyzes the remaining to-be-printed file(s) and displays the result (S607).

After S607 or if all of the to-be-printed file(s) have been analyzed in S606, the CPU (103) performs a fee calculation based on the output methods of the file analysis result and the print fee table (301) held in the ROM (102) (S608). The CPU (103) displays the settlement checking screen (502) on the operation unit (114) (S609), and, when an acceptance is reported on the settlement checking screen (502) (S610), the CPU (103) makes a settlement request to the print settlement system (406) (S611). When the settlement completion is reported by the print settlement system (406) (S612), the CPU (103) prints the to-be-printed file(s) (S613).

If a refusal is reported on the settlement checking screen (502) in S610, the CPU (103) displays the file list screen and the number of pages per output method displayed in S602 and S604 (S614), and returns to S605 to again wait for the selection of one or more files to be printed and for a print request.

This allows the user to accurately check the fee without any decreased convenience or increased cost.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure includes exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2021-175287, filed Oct. 27, 2021, which is hereby incorporated by reference herein in its entirety.

What is claimed is:

1. An image forming apparatus comprising:
an obtaining unit configured to obtain a plurality of files from an external apparatus;
a control unit configured to, for one or some of the plurality of files obtained by the obtaining unit, while applying control to display information on the one or some files on a display unit, apply control not to display information on one or more remaining files on the display unit;
a fee calculation unit configured to calculate a fee for the one or some files in preference to the one or more remaining files; and
an acceptance unit configured to accept a selection of one or more files to be printed from among the one or some files whose information is displayed by the control unit,
wherein the fee calculation unit includes:
a determination unit configured to determine whether each page of each file of the plurality of files obtained by the obtaining unit is a color page or a monochrome page; and
a unit configured to calculate a fee for printing each file based on a result of determination of each page performed by the determination unit.

2. The image forming apparatus according to claim 1, further comprising:
a second determination unit connected to a fee settlement system and configured to determine whether the calculated fee has been settled; and
a print unit configured to print one or more files whose fee has been settled based on a determination that the fee has been settled.

3. The image forming apparatus according to claim 1, wherein the external apparatus is an external storage medium.

4. A method for controlling an image forming apparatus, the method comprising:
obtaining a plurality of files from an external apparatus;
for one or some of the plurality of files obtained in the obtaining, while applying control to display information on the one or some files, applying control not to display information on one or more remaining files;
calculating a fee for the one or some files in preference to the one or more remaining files; and
accepting a selection of one or more files to be printed from among the one or some files whose information is displayed in the applying,
wherein the calculating includes:
determining whether each page of each file of the plurality of files obtained in the obtaining is a color page or a monochrome page; and
calculating a fee for printing each file based on a result of determination of each page.

5. The method according to claim 4, further comprising:
determining whether the calculated fee has been settled; and
printing one or more files whose fee has been settled based on a determination that the fee has been settled.

6. The method according to claim 4, wherein the external apparatus is an external storage medium.

7. A non-transitory computer-readable storage medium storing a program causing a computer to execute a process, the process comprising:
obtaining a plurality of files from an external apparatus;
for one or some of the plurality of files obtained in the obtaining, while applying control to display information on the one or some files, applying control not to display information on one or more remaining files;
calculating a fee for the one or some files in preference to the one or more remaining files; and
accepting a selection of one or more files to be printed from among the one or some files whose information is displayed in the applying,
wherein the calculating includes:
determining whether each page of each file of the plurality of files obtained in the obtaining is a color page or a monochrome page; and
calculating a fee for printing each file based on a result of determination of each page.
